(19) United States
(12) Patent Application Publication
(10) Pub. No.: US 2007/0277681 A1
(43) Pub. Date: Dec. 6, 2007

(54) Roaster oven for roasting pizza and other food

(76) Inventor: Ching-Hsiang Wang, Tainan City (TW)

Correspondence Address: Ching-Hsiang Wang, P.O. Box 90, Tainan City, 70499, omitted

(21) Appl. No.: 11/442,346

(22) Filed: May 30, 2006

(51) Int. Cl. A23B 4/044

(52) U.S. Cl. 99/482

(57) ABSTRACT

A roaster oven for roasting pizza and other food includes a housing having its interior formed with at least two accommodating chambers. Each accommodating chamber has its opposite inner sidewalls respectively and correspondingly provided with positioning members, and its inner upper and lower sides respectively and oppositely installed with electric heating tubes. The housing has its faceplate disposed thereon with control rotary selectors for setting roasting time and temperature, and one of the two accommodating chambers of the roaster oven is movably provided therein with a pizza holder. By so designing, the roaster oven of this invention can be used for roasting pizza and other food simultaneously or respectively.

### BACKGROUND OF THE INVENTION

1. Field of the Invention

This invention relates to a roaster oven, particularly to one having a function of roasting pizza and other food simultaneously or respectively, needless to take much space and convenient in use.

2. Description of the Prior Art

According to different functions, conventional roaster ovens are different in structure. Most conventional roaster ovens are used for roasting meat, chicken, cake or the like; therefore, each of them must be formed with a comparatively large accommodating space for receiving food to be roasted, with its faceplate provided with different rotary selectors for controlling time and temperature of roasting different foods. In general, to avoid wasting energy source, people have to purchase various kinds of roaster ovens for roasting different foods, resulting in taking too much space in a kitchen.

### SUMMARY OF THE INVENTION

The objective of the invention is offer a roaster oven able to roasting pizza and other food simultaneously or respectively, convenient in use and taking less space.

The roaster oven for roasting pizza and other food in the present invention includes a housing having its interior formed with at least two accommodating chambers. Each accommodating chamber has one (plural) positioning member(s) respectively and correspondingly provided at its opposite inner sidewalls and also has electric heating tubes respectively and oppositely installed at the inner upper and lower side. In addition, the housing has its faceplate disposed with control rotary selectors for setting roasting time and temperature, and one of the two accommodating chambers is provided therein with a pizza holder.

### BRIEF DESCRIPTION OF DRAWINGS

This invention will be better understood by referring to the accompanying drawings, wherein:

FIG. 1 is an exploded perspective view of a roaster oven for roasting pizza and other food in the present invention;

FIG. 2 is a perspective view of the roaster oven for roasting pizza and other food in the present invention; and

FIG. 3 is a cross-sectional view of the roaster oven for roasting pizza and other food in a using condition in the present invention.

### DETAILED DESCRIPTION OF THE PREFERRED EMBODIMENT

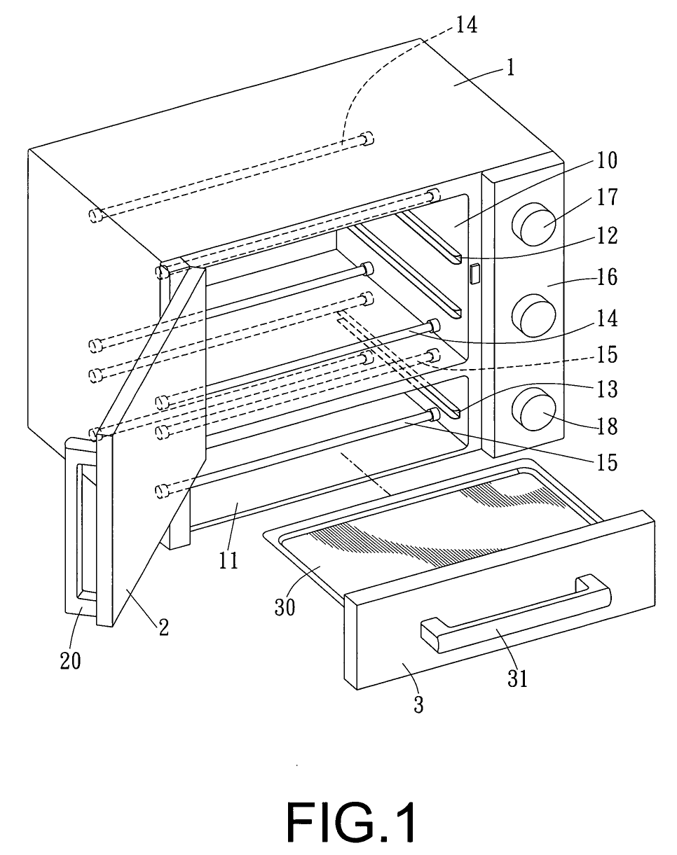

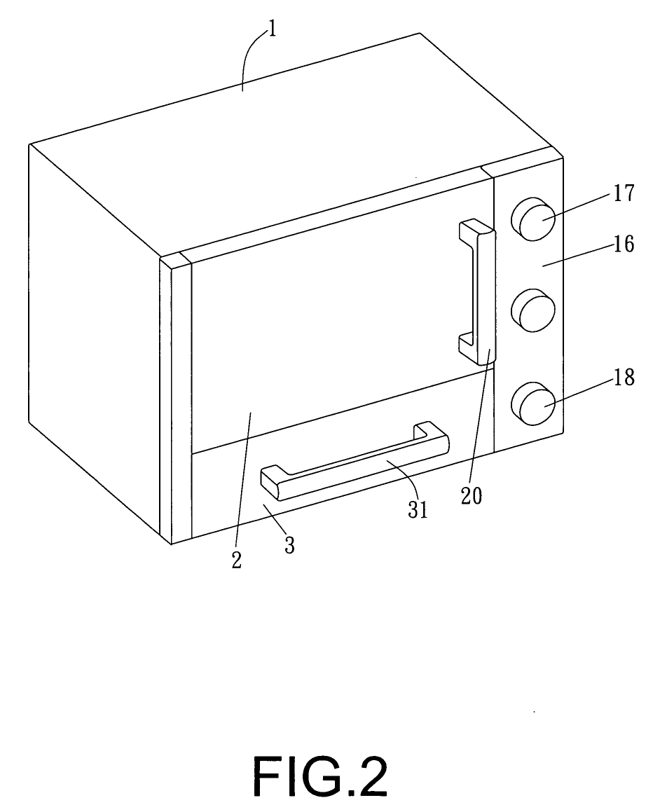

A preferred embodiment of a roaster oven for roasting pizza and other food in the present invention, as shown in FIGS. 1, 2 and 3, includes a housing 1, a plate door 2, a pizza holder 3 and a food tray 4 as main components combined together.

The housing 1 has its interior formed with an upper accommodating chamber 10 and a lower accommodating chamber 11. The upper accommodating chamber 10 has plural insert rails 12 respectively and correspondingly provided at the opposite inner sidewalls, and the lower accommodating chamber 11 has its opposite inner sidewalls respectively and correspondingly provided with an insert rails 13. Further, the upper and the lower accommodating chamber 10, 11 have their inner upper and lower side respectively and correspondingly installed with two electric heating tubes 14. The faceplate 16 of the housing 1, corresponding to the upper accommodating chamber 10, is provided thereon with plural control rotary selectors 17, and the faceplate 16 of the housing 1 matching with the lower accommodating chamber 11 is provided with a control rotary selector 18.

The plate door 2 to be pivotally connected to the front side of the upper accommodating chamber 10 is provided thereon with a door handle 20.

The pizza holder 3 to be movably positioned in the lower accommodating chamber 11 is provided with a holding tray 30 and has its front wall fixed with a pull grip 31.

The food tray 4 is to be positioned in the interior of the upper accommodating chamber 10.

In using, as shown in FIGS. 1, 2 and 3, to roast pizza 50, simply pull the pizza holder 3 out of the lower accommodating chamber 11 of the housing 1 and place a pizza 50 to be roasted on the holding tray 30 of the pizza holder 3. Next, insert the opposite edges of the holding tray 30 of the pizza holder 3 in the opposite insert rails 13 of the lower accommodating chamber 11 and then push the pizza holder 3 into the lower accommodating chamber 11. Lastly, the control rotary selectors 18 is turned to a required position to start the electric heating tubes 15 in the lower accommodating chamber 11 to produce heat energy for carrying out roasting of the pizza 50 in the lower accommodating chamber 11.

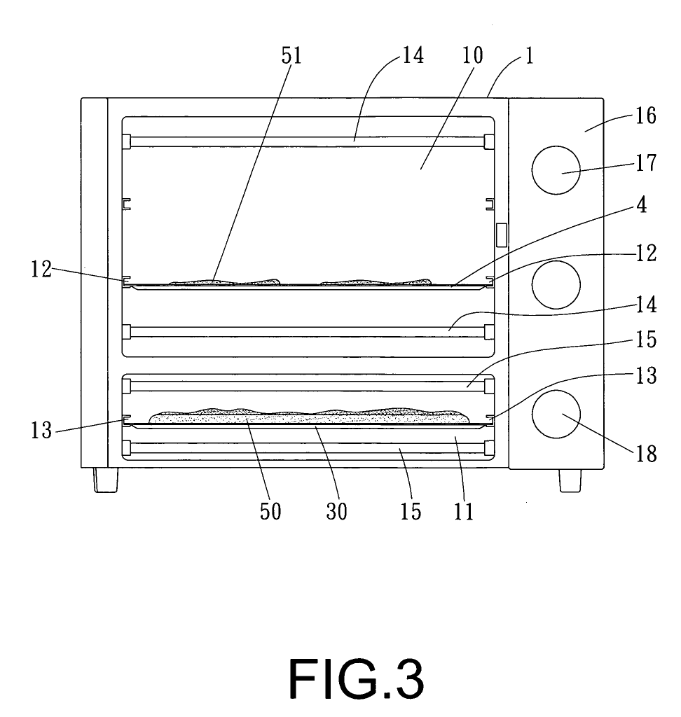

To roast other food 51, such as meat, sausage or the like, as shown in FIG. 3, only pull out the food tray 4 from the insert rails 12 of the upper accommodating chamber 10 and place the food 51 to be roasted on the food tray 4. Next, insert the opposite edges of the food tray 4 in the opposite insert rails 12 of the upper accommodating chamber 10 and then close the plate door 2. Lastly, the two control rotary selectors 17 are respectively turned to a needed position indicating roasting temperature and time required to start the electric heating tubes 14 in the upper accommodating chamber 10 to produce heat energy for carrying out roasting of the food 51 in the upper accommodating chamber 10. By so designing, pizza 50 and other food 51 can be roasted at the same time in the upper and the lower accommodating chamber 10, 11 of the housing 1 or roasted respectively.

As can be understood from the above description, this invention has the following advantages.

1. The roaster oven of this invention can be used for roasting pizza and other food simultaneously or respectively, saving cost in purchasing different roaster ovens and reducing space for them.

2. Pizza and other food can be roasted at the same time, convenient in use and able to economize energy source

While the preferred embodiment of the invention has been described above, it will be recognized and understood that various modifications may be made therein and the appended claims are intended to cover all such modifications that may fall within the spirit and scope of the invention.

What is claimed is:

1. A roaster oven for roasting pizza and other food, said oven comprising an housing, said housing having its interior formed with at least two accommodating chambers, each said accommodating chamber provided with one (plural) positioning member(s) respectively and correspondingly positioned at the opposite inner sidewalls, each said accommodating chamber having its inner upper and lower sides respectively and oppositely installed with electric heating tubes, said housing having a faceplate provided with control rotary selectors for setting roasting time and temperature needed, one of said two accommodating chambers movably provided therein with a pizza holder.

2. The roaster oven for roasting pizza and other food as claimed in claim 1, wherein said positioning members are insert rails.

3. The roaster oven for roasting pizza and other food as claimed in claim 1, wherein said pizza holder is provided with a holding tray.
